(19) United States
(12) Patent Application Publication
(10) Pub. No.: US 2026/0235502 A1
(43) Pub. Date: Aug. 13, 2026

(54) OPTICAL CONCENTRATION MEASURING DEVICE

(71) Applicant: Asahi Kasei Microdevices Corporation, Tokyo (JP)

(72) Inventors: Shota ISSHIKI, Tokyo (JP); Takaaki FURUYA, Tokyo (JP)

(73) Assignee: Asahi Kasei Microdevices Corporation, Tokyo (JP)

(21) Appl. No.: 19/454,750

(22) Filed: Jan. 21, 2026

(30) Foreign Application Priority Data
Feb. 7, 2025 (JP) 2025-019614
Dec. 24, 2025 (JP) 2025-281143

(51) Int. Cl. G01N 21/3504

(52) U.S. Cl. CPC G01N 21/3504; G01N 2201/0636; G01N 2201/08

(57) ABSTRACT

An optical concentration measuring device (1) including a substrate (2), a light emitter (3), a light receiver (4), and a light guide (5). The light guide includes a first reflector (51) and a second reflector (52). The first reflector has a main reflective surface (53) and two secondary reflective surfaces (54), at least a portion of each of which is a quadric surface. Light spots occur on the main reflective surface in a lateral view looking from the second reflector to the front of the main reflective surface. The first reflector comprises a correction surface configured to correct at least one of the light spots. The correction surface is provided between the main reflective surface and at least one of the two secondary reflective surfaces, and extends in a direction along which the first reflector and the second reflector face each other.

### CROSS-REFERENCE TO RELATED APPLICATION

The present application claims priority to and the benefit of Japanese Patent Application No. 2025-019614 filed Feb. 7, 2025, and Japanese Patent Application No. 2025-281143 filed Dec. 24, 2025, the entire contents of which are incorporated herein by reference.

### TECHNICAL FIELD

The present disclosure relates to optical concentration measuring devices.

### BACKGROUND

For example, optical concentration measuring devices that detect gas concentrations are used in various fields. An optical concentration measuring device includes, for example, a light source that emits infrared rays and a detector that detects infrared rays of a specific wavelength, in a single case. Gas to be detected is introduced into the case.

Here, in order to realize an optical concentration measuring device that is compact and has high measurement precision, a multipass cell may be used, in which a pair of mirrors are disposed opposite each other and light is reflected multiple times between the mirrors. Even at the same size, the use of a multipass cell increases the optical path length. Therefore, the effect of disturbance may be reduced, and a compact optical concentration measuring device that has high measurement precision may be realized (for example, see Patent Literature (PTL) 1).

### CITATION LIST

### Patent Literature

PTL 1: JP 2024-132879 A

### SUMMARY

### Technical Problem

In an optical concentration measuring device, when an incoherent light source is used instead of a laser light source, a light spot will widen. Further, when multipass cells are mass-produced rather than being fabricated as one-of-a-kind items, processing errors will generally occur. When a reflective surface of a mirror has a deviation from a designed surface due to such a processing error, light reflection from the surface with the error will not occur as designed. As a result, an optical image may be distorted from a designed shape. In particular, when an incoherent light source is used, a light spot becomes wider than when a laser light source is used, and light reflection is likely to occur on a reflective surface where a processing error exists. That is, when an incoherent light source is used, a shape of an optical image is more likely to be distorted than when a laser light source is used. When a shape of an optical image is distorted, and a disturbance occurs during use of an optical concentration measuring device, an amount of light received by a light receiver is more likely to change than when the shape of the optical image is not distorted. As a result, shape distortion of an optical image leads to a decrease in measurement precision of an optical concentration measuring device. Therefore, there is a demand for technology that can suppress the influence of optical image distortion due to processing errors and prevent a decrease in measurement precision in optical concentration measuring devices that use an incoherent light source and a multipass cell.

In view of the above, it would be helpful to provide an optical concentration measuring device that suppresses the influence of distortion of an optical image due to processing errors.

### Solution to Problem

(1) An optical concentration measuring device according to an embodiment of the present disclosure comprises:
a substrate;
a light emitter on a main surface of the substrate and configured to emit light;
a light receiver on the main surface and configured to receive at least a portion of the light emitted by the light emitter; and
a light guide configured to guide at least a portion of the light emitted by the light emitter to the light receiver, wherein
the light guide comprises a first reflector and a second reflector, the first reflector and the second reflector are on the main surface of the substrate opposite each other in an overhead view looking directly at the main surface of the substrate,
the first reflector comprises a main reflective surface and two secondary reflective surfaces, at least a portion of each of which is a quadric surface,
the second reflector comprises two quadric surfaces,
light spots occur on the main reflective surface in a lateral view looking from the second reflector to the front of the main reflective surface,
the first reflector comprises a correction surface configured to correct at least one of the light spots, and
the correction surface is provided between the main reflective surface and at least one of the two secondary reflective surfaces, and extends in a direction along which the first reflector and the second reflector face each other.

(2) As an embodiment of the present disclosure, (1), wherein
a height of the main reflective surface is 1.5 times to 2.5 times a height of at least one of the two secondary reflective surfaces, with a direction perpendicular to the main surface being the height direction.

(3) As an embodiment of the present disclosure, (1) or (2), wherein
a height of the correction surface is equal to or greater than half a height of the main reflective surface, with a direction perpendicular to the main surface being the height direction.

(4) As an embodiment of the present disclosure, any one of (1) to (3), wherein,
in the lateral view, the main reflective surface extends above each of the two secondary reflective surfaces, and an extension width is 0.3 times or less a longest width of the two secondary reflective surfaces.

(5) As an embodiment of the present disclosure, any one of (1) to (4), wherein, in the lateral view, the main reflective surface has a structure with a radius of 0.2 mm to 0.5 mm at left and right ends.

(6) As an embodiment of the present disclosure, any one of (1) to (5), wherein,
at an upper portion of the main reflective surface, a shape of at least one of the light spots is changed and corrected.

(7) As an embodiment of the present disclosure, any one of (1), (2), (4), (5), or (6), wherein
the correction surface is provided in the main reflective surface.

(8) An optical concentration measuring device according to an embodiment of the present disclosure comprises:
a substrate;
a light emitter on a main surface of the substrate and configured to emit light;
a light receiver on the main surface and configured to receive at least a portion of the light emitted by the light emitter; and
a light guide configured to guide at least a portion of the light emitted by the light emitter to the light receiver, wherein
the light guide comprises a first reflector and a second reflector, the first reflector and the second reflector are on the main surface of the substrate opposite each other in an overhead view looking directly at the main surface of the substrate, the first reflector comprises a main reflective surface and two secondary reflective surfaces, at least a portion of each of which is a quadric surface, the second reflector comprises two quadric surfaces, light spots occur on the main reflective surface in a lateral view looking from the second reflector to the front of the main reflective surface, and the first reflector comprises a correction surface that connects the main reflective surface and at least one of the two secondary reflective surfaces.

### Advantageous Effect

According to an embodiment of the present disclosure, it is possible to provide an optical concentration measuring device that suppresses the influence of distortion of an optical image due to a processing error.

### BRIEF DESCRIPTION OF THE DRAWINGS

In the accompanying drawings:

FIG. 1 is a partially transparent perspective diagram of an optical concentration measuring device according to an embodiment of the present disclosure;

FIG. 2 is a diagram illustrating a multipass optical path between a first reflector and a second reflector;

FIG. 3 is a diagram illustrating a configuration of a first reflector and light spots in a lateral view;

FIG. 4 is a diagram illustrating a relationship between a processing error and a distance from a processing reference;

FIG. 5A is a diagram illustrating an optical image on a light-receiving surface of an optical concentration measuring device according to an embodiment of the present disclosure;

FIG. 5B is a diagram illustrating an optical image on a light-receiving surface of a comparative example; and

FIG. 6 illustrates other examples of light spots.

### DETAILED DESCRIPTION

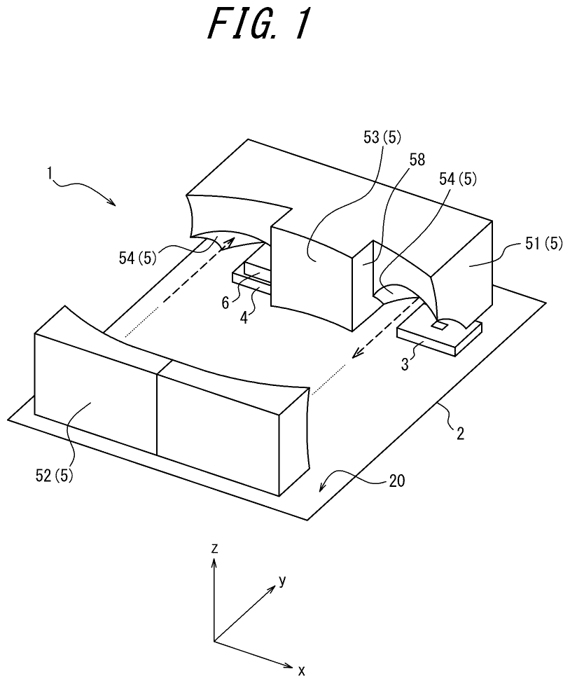

FIG. 1 is a partially transparent perspective diagram of an optical concentration measuring device 1 according to an embodiment of the present disclosure. The optical concentration measuring device 1 is a compact device, 20 mm×10 mm×10 mm as an example, and is also referred to as a gas sensor. According to the present embodiment, the optical concentration measuring device 1 is a non-dispersive infrared (NDIR) type device that measures the concentration of a gas to be detected based on infrared radiation transmitted through a gas that is introduced. The gas to be detected may be, for example, carbon dioxide, water vapor, methane, propane, formaldehyde, carbon monoxide, nitrogen monoxide, ammonia, sulfur dioxide, alcohol, or the like, or a mixture of any of these gases.

Here, the wavelength of the light (infrared light according to the present embodiment) may be 2 μm to 10 μm. The range of 2 μm to 10 μm contains many absorption bands specific to various gases, making it a wavelength range particularly suitable for use in gas sensors. For example, there is an absorption band for methane at a wavelength of 3.3 μm, for carbon dioxide at a wavelength of 4.3 μm, and for alcohol (ethanol) at a wavelength of 9.5 μm.

The configuration of the optical concentration measuring device 1 according to the present embodiment allows use as a light emitting and receiving device for applications other than gas detection. That is, disclosure content derived by replacing “optical concentration measuring device 1” as described above with “concentration measuring device”, “optical physical quantity measuring device”, “light receiving and emitting device”, “optical device”, or the like is included in the scope of the present disclosure. For example, the state of an optical path space can be detected (examples other than gas include the presence or absence or concentration of a specific component of a fluid). For example, the disclosure content can be used for a component detection device or a component concentration measuring device for a substance (for example, water or a body fluid) present in an optical path space between a light emitter 3 and a light receiver 4. For example, when the substance present in the optical path space is blood, the component detection device or the component concentration measuring device can be used to measure glucose concentration in blood.

The component detection device or the component concentration measuring device can measure glucose concentration in blood by measuring absorption of light having a wavelength of 1 μm to 10 μm. In the measurement of glucose concentration in blood, measuring absorption of light in a 1.6 μm band, a 2.0 μm band, and a 10.0 μm band is preferred. A compact, high precision, and highly reliable non-invasive glucose concentration meter can be realized. Such a glucose concentration meter allows, for example, a diabetic patient to self-check blood sugar levels with good precision and without causing damage to the skin as would occur with an invasive method. Further, more accurate administration of medication (for example, insulin) can be achieved, based on the blood sugar levels checked.

The optical concentration measuring device 1 includes a substrate 2, a light emitter 3, a light receiver 4, and a light guide 5. As per the present embodiment, the optical concentration measuring device 1 may further include an optical filter 6. FIG. 1 illustrates an example configuration of the optical concentration measuring device 1 with a portion of the light guide 5 made transparent, and the light emitter 3, the light receiver 4, and the optical filter 6 on a main surface 20 of the substrate 2 visible. According to the present embodiment, the main surface 20 is the surface with the largest area of the substrate 2 on which the light guide 5 is disposed. The light guide 5 may be at least a part of a housing provided to cover the main surface 20. By integrating the light guide 5 with the housing, it is possible to omit a process of adjusting tolerances that would be required when incorporating a mirror of the light guide 5 as a separate component, thereby achieving high robustness. However, the light guide 5 need not be integrated with the housing.

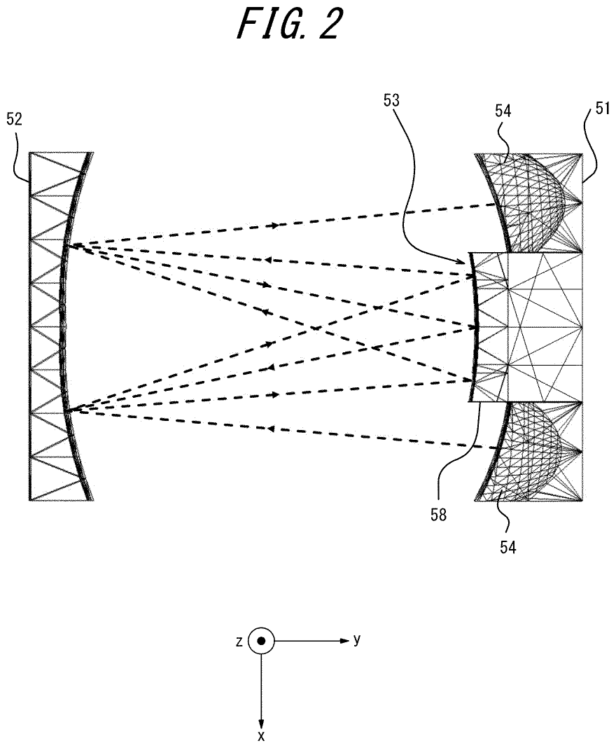

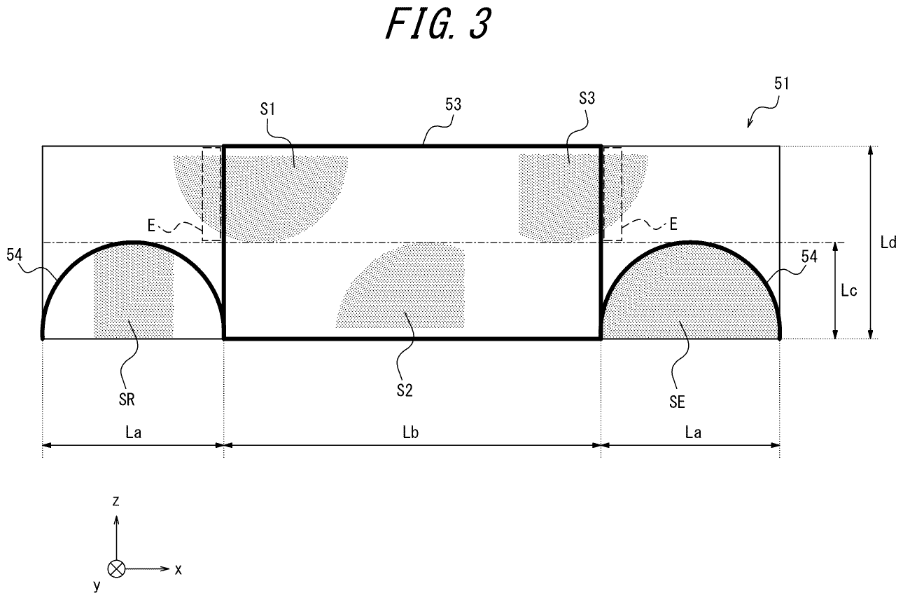

Hereinafter, as illustrated in FIG. 1, a Cartesian coordinate system is set so that an xy-plane is parallel to the main surface 20 of the substrate 2. The Cartesian coordinate system is used in FIG. 2 and FIG. 3. The z-axis direction is perpendicular to the main surface 20 of the substrate 2. The z-axis direction may also be referred to as the height direction. The x-axis direction and the y-axis direction are parallel to edges of the main surface 20 of the substrate 2. Hereinafter, the view of the front of the main surface 20 of the substrate 2 may also be referred to as the overhead view. The viewing direction in the case of the overhead view corresponds to the negative z-axis direction.

The substrate 2 is a board-like member that mounts components of the optical concentration measuring device 1 and makes electrical connections for mounted electronic components. According to the present embodiment, the substrate 2 is a printed circuit board (PCB). The material of the substrate 2 may be, for example, paper, glass cloth, ceramic, polyimide, liquid crystal polymer, or the like. The substrate 2 has the light emitter 3, the light receiver 4, and the light guide 5 mounted on the main surface 20. The substrate 2 may also have the optical filter 6 mounted on the main surface 20. The substrate 2 may further mount other electronic components. For example, the substrate 2 may be provided with a controller that controls at least one of the light emitter 3 or the light receiver 4 on the main surface 20 or on a bottom surface that is the opposite side to the main surface 20. Further, the substrate 2 may be provided with an arithmetic unit on the main surface 20 or on the bottom surface to execute arithmetic operations in gas concentration calculation. The arithmetic unit may include at least one general-purpose processor that executes functions according to a program to be read and may include at least one dedicated processor specialized for a particular process. The dedicated processor may include an application specific integrated circuit (ASIC). The arithmetic unit may be integrated with the controller described above.

The light emitter 3 is a component that emits light used to detect the gas to be detected. The light emitter 3 is not particularly limited as long as the light emitter 3 outputs light including a wavelength that is absorbed by the gas to be detected. According to the present embodiment, the light emitted by the light emitter 3 is infrared light, but is not limited to this example. According to the present embodiment, the light emitter 3 is a light emitting diode (LED), and emits light from a light-emitting surface. The light-emitting surface is a surface of the light emitter 3 that is in contact with the gas and is made of an optically transparent material. According to the present embodiment, the light emitter 3 is a surface light source that emits light from a light-emitting surface, but is not limited to being a surface light source. As other examples, the light emitter 3 may be an organic light-emitting element, a lamp, a micro-electromechanical systems (MEMS) heater, or the like. The light emitter 3 is disposed on the main surface 20 of the substrate 2, opposite one of the secondary reflective surfaces 54, described below.

The light receiver 4 is a component that receives light transmitted through the gas that is introduced. The light receiver 4 receives at least a portion of the light emitted by the light emitter 3. The light receiver 4 is not particularly limited as long as the light receiver 4 is sensitive to a band of light that includes a wavelength absorbed by the gas to be detected. According to the present embodiment, light received by the light receiver 4 is infrared light, but is not limited to this example. According to the present embodiment, the light receiver 4 is a photodiode that receives light at a light-receiving surface. Here, the light-receiving surface is a surface of the light receiver 4 that is in contact with the gas and is made of an optically transparent material. As other examples, the light receiver 4 may be a phototransistor or thermopile, a pyroelectric sensor, a bolometer, or the like. The light receiver 4 converts received light into an electrical signal and outputs the converted electrical signal. The electrical signal is output to, for example, an arithmetic unit. Upon receiving the electrical signal, the arithmetic unit calculates the concentration of the gas to be detected, based on light transmittance and the like. The light receiver 4 is disposed on the main surface 20 of the substrate 2, opposite the other one of the secondary reflective surfaces 54, described below.

According to the present embodiment, the light receiver 4 includes the optical filter 6 that has a wavelength selection function. The optical filter 6 transmits light emitted from the light emitter 3 and reflected by the light guide 5 to reach the light-receiving surface of the light receiver 4. Here, the optical filter 6 need only be provided on the optical path and need not be included in the light receiver 4. The optical filter 6 may be, for example, a diffraction grating that spatially separates wavelengths by utilizing diffraction. The optical concentration measuring device 1 may be configured without the optical filter 6.

The light guide 5 is a member that guides at least a portion of the light emitted by the light emitter 3 to the light receiver 4. The light guide 5 is an optical system of the optical concentration measuring device 1. The light guide 5 includes optical members and configures the optical path from the light emitter 3 to the light receiver 4. In other words, the light guide 5 optically connects the light emitter 3 and the light receiver 4. Here, an optical member is, for example, a mirror. The optical members may also include a lens or the like.

According to the present embodiment, the light guide 5 includes a first reflector 51 and a second reflector 52. As illustrated in FIG. 1, the first reflector 51 and the second reflector 52 are provided to the main surface 20 of the substrate 2 and are opposite each other in the overhead view. Further, the first reflector 51 and the second reflector 52 may be held in a structure that has a function of holding the relative positions of the first reflector 51 and the second reflector 52, and the structure may be in the form of a connection to the main surface 20 of the substrate 2.

The first reflector 51 includes a main reflective surface 53 and the two secondary reflective surfaces 54, at least a portion of each of which is a quadric surface. Here, quadric surfaces may include, for example, parabolic, ellipsoidal, spherical surfaces, and the like, and may have rotational axis symmetry. For the main reflective surface 53 and each of the two secondary reflective surfaces 54, an entire reflective portion may be a quadric surface, or a portion of the reflective portion may have a shape that includes a flat surface. A flat surface of the reflective portion may be configured so that a length of one edge, either vertically or horizontally, is 0.3 mm or less, for example. The length of one edge of the flat surface of the reflective portion refers to the length of a line segment obtained when the flat surface is projected perpendicularly to either the x-axis or the z-axis in the lateral view of the first reflector 51, that is, when the main reflective surface 53 of the first reflector 51 is viewed from the second reflector 52 directly in front.

The second reflector 52 comprises two quadric surfaces. For example, the second reflector 52 may be configured to have two spherical surfaces joined together at a reflective surface opposite the first reflector 51. The entire reflective portion of the second reflector 52 may be a quadric surface, or may have a shape that includes a flat surface in part of the reflective portion. A flat surface of the reflective portion may be configured so that a length of one edge, either vertically or horizontally, is 0.3 mm or less, for example. The length of one edge of the flat surface of the reflective portion refers to the length of a line segment obtained when the flat surface is projected perpendicularly onto either the x-axis or the z-axis when viewed from the other side view in the opposite direction to the lateral view. That is, the other side view is a view from the first reflector 51 to the second reflector 52 looking straight ahead. The viewing direction in the case of the other side view corresponds to the negative y-axis direction.

Here, the first reflector 51 has three functions. The first function is to reflect light emitted from the light emitter 3 in the z-axis direction in the xy plane direction perpendicular to the z-axis direction. Here, the xy plane direction is a direction having a component in at least one of the x-axis direction and the y-axis direction. However, the xy plane direction may include a z-axis direction component. The second function is to cause multiple reflections of light with the second reflector 52. The third function is to reflect the multipass light to the light receiver 4.

Further, the first reflector 51 further includes a correction surface 58. The correction surface 58 may be a surface that connects the main reflective surface 53 and the secondary reflective surface 54. The correction surface 58 defines the width of the main reflective surface 53. Although details are described later, the first reflector 51 also has a fourth function of correcting a light spot via the correction surface 58.

One of the secondary reflective surfaces 54, the one near the light emitter 3, reflects the light emitted from the light emitter 3. The light reflected by the one of the secondary reflective surfaces 54 is reflected by the second reflector 52 and the main reflective surface 53 to traverse back and forth between the second reflector 52 and the main reflective surface 53 multiple times. The optical path is configured to traverse through a cell (internal space) between the light guide 5 and the substrate 2, where gas is introduced. The other one of the secondary reflective surfaces 54, near the light receiver 4, reflects light from the second reflector 52 and guides the light to the light receiver 4. Here, the light guide 5 may be configured to include a lens in a portion of the optical path. The one of the secondary reflective surfaces 54 near the light emitter 3 and the other one of the secondary reflective surfaces 54 near the light receiver 4 are both quadric surfaces, but need not include the same curved surface.

FIG. 2 illustrates a multipass optical path between the first reflector 51 and the second reflector 52. Here, when the total number of optical paths from the first reflector 51 to the second reflector 52 and from the second reflector 52 to the first reflector 51 is N, then ((N/2)−1) light spots occur on the main reflective surface 53. According to this calculation, one optical path is defined as one traversal straight through the internal space until reflection. Here, the path of light from the light emitter 3 to the one of the secondary reflective surfaces 54 and the path of light from the other one of the secondary reflective surfaces 54 to the light receiver 4 are not counted in the optical paths. FIG. 2 is a diagram illustrating a case where the total number of optical paths between the first reflector 51 and the second reflector 52 is eight. However, the optical paths in FIG. 2 are just an example, and the total number (N) of optical paths may be 12, 16, 20, etc.

Material of the main reflective surface 53 and the secondary reflective surfaces 54 of the first reflector 51 and the reflective surface of the second reflector 52 may be, but is not limited to, metal, glass, ceramic, stainless steel, and the like. From the viewpoint of improving detection sensitivity, the material of these mirrors is preferably a material that has a low light absorption coefficient and high reflectance. Specifically, a resin housing coated with an alloy containing aluminum, gold, or silver, a dielectric, or a laminate thereof is preferred. From the viewpoint of reliability and aging, a resin housing coated with gold or an alloy layer containing gold is preferred. Vapor deposition or coating applied to a resin housing may provide improved productivity and lighter weight compared to forming with a metal material. Further, a difference in thermal expansion coefficient from the substrate 2 is reduced, thermal deformation is suppressed, and sensitivity fluctuation is suppressed.

Further, the correction surface 58 only needs to have the function of excluding some of the light from the optical path that causes the light to be reflected multiple times between the first reflector 51 and the second reflector 52, and may be a flat surface, a curved surface, a combination of a flat surface and a curved surface, or a surface having periodicity. The correction surface 58 may be provided between the main reflective surface 53 and at least one of the two secondary reflective surfaces 54, and may extend in a direction in which the first reflector 51 and the second reflector 52 face each other. Further, the correction surface 58 may reflect light in a direction different from the multipass optical path, or may absorb light. For example, in the lateral view, the main reflective surface 53 has a structure (curved surface) with a radius of 0.2 mm to 0.5 mm at the left and right ends, and the correction surface 58 may remove some of the light from the optical path by using the curved surface (that is, may reflect in a direction different from the multipass optical path). The lateral view is a view of the front of the main reflective surface 53 of the first reflector 51 from the second reflector 52. The viewing direction in the case of the lateral view corresponds to the positive direction of the y-axis. Here, in the case of a configuration in which light is reflected, the correction surface 58 may be made of the same material as the first reflector 51 and the second reflector 52.

FIG. 3 is a diagram illustrating a configuration of the first reflector 51 and light spots in the lateral view. In the lateral view, light spots (S1, S2, and S3) occur on the main reflective surface 53, and the light spots are arranged in horizontal and vertical directions. Here, the x-axis direction corresponds to the horizontal direction in the lateral view. Further, the z-axis direction corresponds to the vertical direction. In the example in FIG. 3, the light spots are arranged not only in the horizontal direction, but also in two levels in the vertical direction. Further, the center of an upper light spot is positioned to be offset in the horizontal direction relative to the center of a lower light spot. The center of each light spot is a position of maximum light intensity in the light spot. Here, the lower light spots also include a light spot (SE) on the secondary reflective surface 54 toward the light emitter 3 side and a light spot (SR) on the secondary reflective surface 54 toward the light receiver 4 side. Such an arrangement of the light spots makes it possible to have a configuration in which many light spots exist in a limited reflection area.

As described above, the first reflector 51 may include the correction surface 58 between the main reflective surface 53 and at least one of the two secondary reflective surfaces 54, which corrects at least one light spot of the light spots. According to the present embodiment, the first reflector 51 has two correction surfaces 58 to the left and right of the main reflective surface 53. Among the light spots, light that is irradiated onto the correction surfaces 58 (that is, light that is outside the region of the main reflective surface 53) is removed from the multipass optical path between the first reflector 51 and the second reflector 52. Accordingly, the shape of the light spot changes and is corrected. In the example of FIG. 3, the light spot (SE) on the secondary reflective surface 54 on the light emitter 3 side is reflected by the second reflector 52, reaches the main reflective surface 53, and becomes the light spot (S1). A portion of the light spot (S1) is outside the region of the main reflective surface 53 due to the presence of the correction surface 58, and therefore the shape of the light spot (S1) is changed. The light spot (S1) is reflected by the second reflector 52 and reaches the main reflective surface 53 again to become the light spot (S2). The light spot (S2) is then reflected by the second reflector 52 and reaches the main reflective surface 53 again to become the light spot (S3). A portion of the light spot (S3) is outside the region of the main reflective surface 53 due to the presence of the correction surface 58, and therefore the shape of the light spot (S3) is changed. The light spot (S3) is reflected by the second reflector 52, reaches the secondary reflective surface 54 on the light receiver 4 side, and becomes the light spot (SR). In this way, the first reflector 51 has a structure including the correction surface 58, and therefore the shape of at least one of the light spots is changed and corrected in the upper portion of the main reflective surface 53 (the portion above the secondary reflective surface 54 in the lateral view). The shape of the trimmed light spot after correction may have left-right symmetry or be asymmetrical. Further, the shape of the main reflective surface may have left-right symmetry or be asymmetrical.

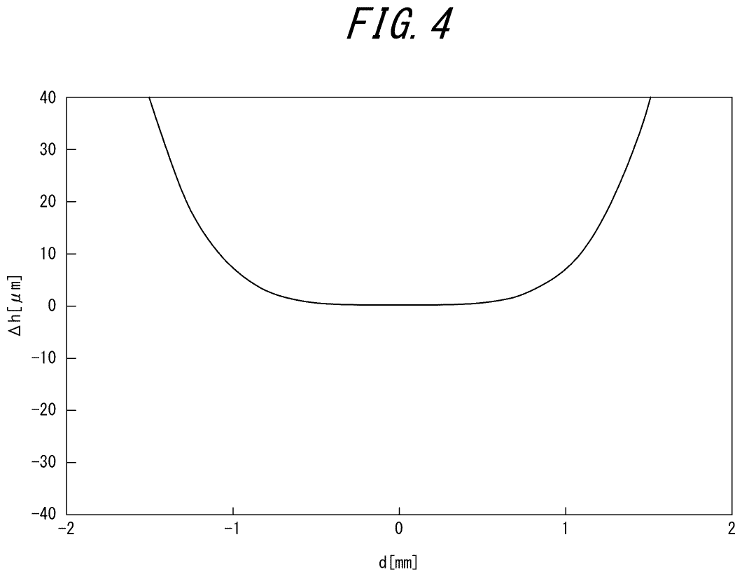

FIG. 4 is a diagram illustrating a relationship between a processing error (Dh) and a distance (d) from a processing reference of the multipass cell. The processing error is a difference between a design value and an actual value (design value-actual value). As illustrated in FIG. 4, as the distance from the processing reference of the multipass cell increases, the processing error increases. In the example of FIG. 4, the processing error is a positive value, but the processing error may be a negative value. Even in the case of a negative value, the magnitude (absolute value) increases as the distance from the processing reference of the multipass cell increases. Here, the first reflector 51 and the second reflector 52 of the multipass cell are approximately symmetrical about the center of the x-axis of the reflector in the lateral view or the other side view. In many cases, design is carried out by arranging a processing reference on a line parallel to the z-axis at the center of each of the first reflector 51 and the second reflector 52 in the x-axis direction. Therefore, the error tends to be large for mirrors located away from the center. Further, each mirror may be designed using the center of each mirror surface present in the first reflector 51 and the second reflector 52 as a processing reference. In such a case, the distance from the processing reference can be made smaller than when a common processing reference is used, and processing errors can be suppressed. However, it is difficult to adjust the positions of the processing reference, and such adjustment can sometimes result in errors. Similarly, when the multipass cell is deformed due to the influence of the use environment (for example, deterioration over time), the error tends to increase as the distance from the processing reference increases. The change (correction) in the shape of the light spot by the main reflective surface 53 corresponds to forming a multipass optical path between the first reflector 51 and the second reflector 52, excluding a portion where the error becomes large. In the case of FIG. 3, the shape of both ends of the light spot (SE) on the secondary reflective surface 54 in the x-axis direction is changed by the main reflective surface 53. When each processing reference is located at the center of each mirror surface, light reflected at both ends of the secondary reflective surface 54 near the light emitter 3 (region where processing errors occur) can be eliminated. Therefore, although the amount of light is slightly decreased, it is possible to suppress the influence of distortion of the optical image due to processing errors and the like.

Referring again to FIG. 3, a preferred configuration of the first reflector 51 is described. It is preferable that a height (Ld) of the main reflective surface 53 is 1.5 times to 2.5 times a height (Lc) of each of the two secondary reflective surfaces 54, with the direction perpendicular to the main surface 20 (the z-axis direction) being the height direction. Here, according to the present embodiment, the heights of the two secondary reflective surfaces 54 are the same, but the heights of the secondary reflective surfaces 54 may be different from each other. In such a case, it suffices that the height of the main reflective surface 53 is 1.5 times to 2.5 times the maximum height of the secondary reflective surfaces 54. As in the present example, when there are multiple secondary reflective surfaces 54, the height of the primary reflective surface 53 is 1.5 times to 2.5 times the height of the secondary reflective surface 54 having the greatest height among the maximum heights of the secondary reflective surfaces 54.

Further, the height of the correction surface 58 is preferably at least half the height of the main reflective surface 53. The height of the correction surface 58 may be set to exceed the height of the secondary reflective surface 54 having the lowest height among the maximum heights of the secondary reflective surfaces 54 so that the shape of the light spot changes and is corrected at the upper portion of the main reflective surface 53. The height of the correction surface 58 may be set to exceed the height of the secondary reflective surface 54 near the light emitter 3, which determines the amount of light introduced into the optical path. The light spot may be corrected at the lower portion of the main reflective surface 53, but during the correction, some of the light may be incident on the secondary reflective surface 54. Therefore, it is preferable that correction be performed only at the upper portion of the main reflective surface 53. Here, as in FIG. 1, the height of the correction surface 58 may be the same as the height of the main reflective surface 53.

Further, in the lateral view, the main reflective surface 53 may extend above each of the two secondary reflective surfaces 54, and an extension width (horizontal length) may be 0.3 times or less the width of each of the two secondary reflective surfaces 54. In the example of FIG. 3, the upper portion of the main reflective surface 53 may include horizontal extension regions E and may be wider than the lower portion. In such a case, the width of the extension region E may be 0.3 times or less the widest of the widths (La) of the two secondary reflective surfaces 54. Here, according to the present embodiment, the widths of the two secondary reflective surfaces 54 are the same, but the widths of the secondary reflective surfaces 54 may be different from each other.

Further, when the total number of optical paths from the first reflector 51 to the second reflector 52 and from the second reflector 52 to the first reflector 51 is eight, it is preferable that a width (Lb) of the main reflective surface 53 is 1.5 times to 2.6 times a width (La) of the two secondary reflective surfaces 54. When the total number of optical paths is 12, the width (Lb) of the main reflective surface 53 is preferably 2.5 times to 3.6 times the width (La) of the two secondary reflective surfaces 54. When the total number of optical paths is 16, the width (Lb) of the main reflective surface 53 is preferably 3.5 times to 4.6 times the width (La) of the two secondary reflective surfaces 54. When the total number of optical paths is 20, the width (Lb) of the main reflective surface 53 is preferably 4.5 times to 5.6 times the width (La) of the two secondary reflective surfaces 54. That is, when the total number of optical paths is N, it is preferable that the width (Lb) of the main reflective surface 53 is (N/4)−0.5 times to (N/4)+0.6 times the widest of the two secondary reflective surfaces 54 (La). This is because the number of light spots formed on the main reflective surface changes. The minimum width of the main reflective surface 53 is (N/4)−0.5 times the widest width (La) of the two secondary reflective surfaces 54 in order to correct the shape of the light spot at the upper portion of the main reflective surface 53 and to make the region removed from the multipass optical path half or less of the width of the light spot. The maximum width of the main reflective surface 53 is (N/4)+0.6 times the widest width (La) of the two secondary reflective surfaces 54, which is determined by the maximum width of the extension region E.

For verification purposes, simulations were carried out to obtain optical images on the light-receiving surface of the light receiver 4 of the optical concentration measuring device 1 according to the present embodiment and a comparative example. The comparative example is a device in which the first reflector 51 does not include the correction surface 58, and the shape of the main reflective surface 53 is extended based on the surface-shape function so that the main reflective surface 53 extends above the two secondary reflective surfaces 54. According to the comparative example, the light spot is not corrected by the main reflective surface 53, and the light from the light emitter 3 is reflected multiple times before reaching the light receiver 4. Simulations were carried out for cases where the processing error of the multipass cell was a typical value (Typ.), −10 μm, and +10 μm. The typical value was a case where the first reflector 51 and the second reflector 52 were fabricated according to the designed values, and the processing error was 0 μm. The processing error in the simulation may be modeled using a function that causes the surface shape of the reflective surface aperture edge to be −10 μm or +10 μm with respect to the typical value. The function used may be a polynomial function, or a combination of a radius of curvature and a conic constant that represent the surface shape of an optical element having rotational symmetry. The aperture edge of the reflective surface is the maximum length in the x-axis and z-axis directions in the lateral view. Processing error modeling may be based on the aperture length in either the x-axis or z-axis.

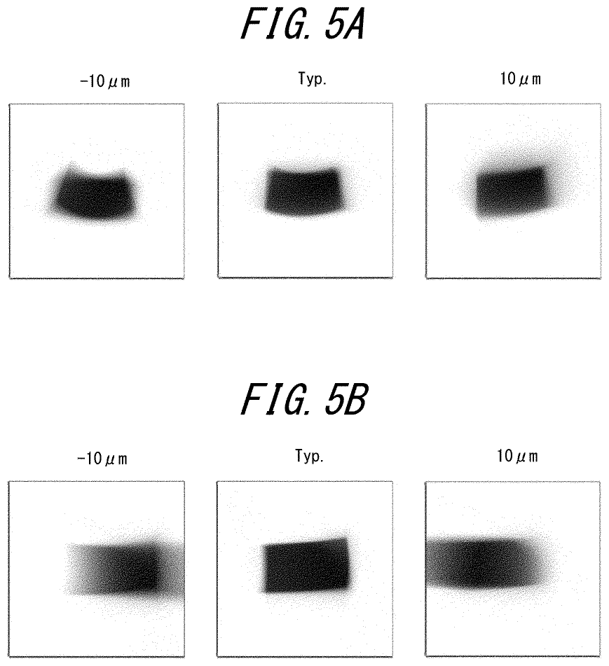

FIG. 5A illustrates simulation results using the optical concentration measuring device 1 according to the present embodiment, in which the optical image was hardly distorted even when the processing error was large. In contrast, FIG. 5B illustrates simulation results for the comparative example, in which the optical image was greatly distorted when the processing error was large. From these comparisons, it was confirmed that the optical concentration measuring device 1 according to the present embodiment can suppress the influence of distortion of an optical image due to processing error.

As described above, the optical concentration measuring device 1 according to the present embodiment, with a configuration described above, suppresses the influence of distortion of an optical image due to processing error, and does not decrease measurement precision.

Although embodiments have been described based on the drawings and examples, it should be noted that a person skilled in the art may easily make variations and modifications based on the present disclosure. Therefore, it should be noted that such variations and modifications are included within the scope of the present disclosure.

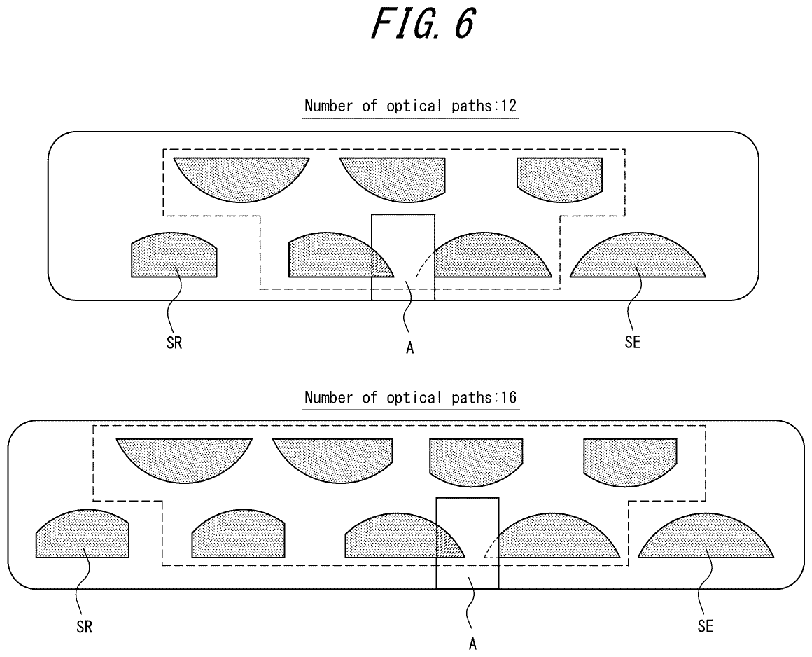

According to an example above, a configuration has been described in which the correction surface 58 is provided between the main reflective surface 53 and at least one of the two secondary reflective surfaces 54, but the position at which the correction surface 58 is provided is not limited as long as it is possible to remove some of the light from the multipass optical path. For example, FIG. 6 illustrates examples of light spots when the number of optical paths is 12 and 16, from the lateral view as in FIG. 3. The dashed line indicates the main reflective surface 53. By providing the correction surface 58 at the position indicated by A in FIG. 6, a portion of the lower light spot is not reflected by the main reflective surface 53, and therefore the shape is changed and corrected. The shape of the trimmed light spot after correction may have left-right symmetry or be asymmetrical. Further, the shape of the main reflective surface may have left-right symmetry or be asymmetrical. In such a case, the region indicated by A in FIG. 6 may be a through-hole in the lateral view or a recess. The correction surface 58 may be a side wall of a through hole or recess, and may change and correct the shape of the light spot. According to the present example, unlike the examples described above, even when the shape of the light spot at the lower portion of the main reflective surface is changed for correction, there is no concern that some of the light may be incident on the secondary reflective surface 54 during the correction. When changing and correcting the shape of the light spot at the lower portion of the main reflective surface 53, there is no need to correct the shape of the light spot above the secondary reflective surfaces 54. Therefore, unlike the conditions in the above example, the width of the extension region E above the secondary reflective surfaces can be 0.8 times or less the widest width of the widths (La) of the two secondary reflective surfaces 54. Further, when changing and correcting the shape of the light spot at the lower portion of the main reflective surface 53, the height of the correction surface 58 may be half or less than that of the main reflective surface 53, since the light spots aligned with the light spots (SE) and (SR) on the secondary reflective surface are the subject of correction. The scope of the present disclosure also includes a configuration in which the correction surface 58 is provided in the main reflective surface 53 (so as to be included in the main reflective surface 53).

1. An optical concentration measuring device comprising:
a substrate;
a light emitter on a main surface of the substrate and configured to emit light;
a light receiver on the main surface and configured to receive at least a portion of the light emitted by the light emitter; and
a light guide configured to guide at least a portion of the light emitted by the light emitter to the light receiver, wherein the light guide comprises a first reflector and a second reflector,
the first reflector and the second reflector are on the main surface of the substrate opposite each other in an overhead view looking directly at the main surface of the substrate,
the first reflector comprises a main reflective surface and two secondary reflective surfaces, at least a portion of each of which is a quadric surface,
the second reflector comprises two quadric surfaces,
light spots occur on the main reflective surface in a lateral view looking from the second reflector to the front of the main reflective surface,
the first reflector comprises a correction surface configured to correct at least one of the light spots, and
the correction surface is provided between the main reflective surface and at least one of the two secondary reflective surfaces, and extends in a direction along which the first reflector and the second reflector face each other.

2. The optical concentration measuring device according to claim 1, wherein a height of the main reflective surface is 1.5 times to 2.5 times a height of at least one of the two secondary reflective surfaces, with a direction perpendicular to the main surface being the height direction.

3. The optical concentration measuring device according to claim 1, wherein a height of the correction surface is equal to or greater than half a height of the main reflective surface, with a direction perpendicular to the main surface being the height direction.

4. The optical concentration measuring device according to claim 1, wherein, in the lateral view, the main reflective surface extends above each of the two secondary reflective surfaces, and an extension width is 0.3 times or less a longest width of the two secondary reflective surfaces.

5. The optical concentration measuring device according to claim 1, wherein, in the lateral view, the main reflective surface has a structure with a radius of 0.2 mm to 0.5 mm at left and right ends.

6. The optical concentration measuring device according to claim 1, wherein at an upper portion of the main reflective surface, a shape of at least one of the light spots is changed and corrected.

7. The optical concentration measuring device according to claim 1, wherein the correction surface is provided in the main reflective surface.

8. An optical concentration measuring device comprising:
a substrate;
a light emitter on a main surface of the substrate and configured to emit light;
a light receiver on the main surface and configured to receive at least a portion of the light emitted by the light emitter; and
a light guide configured to guide at least a portion of the light emitted by the light emitter to the light receiver, wherein the light guide comprises a first reflector and a second reflector,
the first reflector and the second reflector are on the main surface of the substrate opposite each other in an overhead view looking directly at the main surface of the substrate,
the first reflector comprises a main reflective surface and two secondary reflective surfaces, at least a portion of each of which is a quadric surface,
the second reflector comprises two quadric surfaces,
light spots occur on the main reflective surface in a lateral view looking from the second reflector to the front of the main reflective surface, and
the first reflector comprises a correction surface that connects the main reflective surface and at least one of the two secondary reflective surfaces.
